(19) United States
(12) Patent Application Publication
(10) Pub. No.: US 2010/0284652 A1
(43) Pub. Date: Nov. 11, 2010

(54) COMPOSITE BODY

(75) Inventors: Fraser Morrison, Edinburgh (GB); Johannes Lippert, Buch am Wald (DE); Yim-Bun Patrick Kwan, Aalen (DE); Andreas Ochse, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/842,624

(22) Filed: Jul. 23, 2010

Related U.S. Application Data
(62) Division of application No. 11/304,055, filed on Dec. 14, 2005.
(60) Provisional application No. 60/636,955, filed on Dec. 16, 2004.

(51) Int. Cl. G02B 6/42

(52) U.S. Cl. 385/51

(57) ABSTRACT

A composite body is joined together of at least two bodies (13, 16), wherein the first body (16) is a component—or monolithically comprises a component—with very stringent requirements on the precision of its surface (typically an optical component) and wherein the second body (13) can have the broadest diversity of functions, for example carrying parts of a position-measuring arrangement or optical surfaces. Each of the two bodies (13, 16) has at least one connecting surface area (21), and the at least two respective connecting surface areas (21) lie opposite each other. Within the at least one connecting surface area (21) of one of the two bodies (13, 16) or in the proximity of said connecting surface area (21), at least one constructive means is arranged for isolating the first body (16) and/or the second body (13) from deformation.

This application claims the benefit under 35 U.S.C. 119(e)(1) of U.S. Provisional Application No. 60/636,955, filed on Dec. 16, 2004.

### BACKGROUND OF THE INVENTION

The invention relates to a composite body in which at least two bodies are joined together, wherein the first body is an optical component or monolithically comprises an optical component, wherein each of the two bodies has at least one connecting surface area, and wherein the at least two respective connecting surface areas lie opposite each other.

A composite body is disclosed in DE 197 55 482 A1. In this prior-art composite body, there are a first and a second body connected to each other by wringing; the bodies can consist of different materials. Each of the two bodies has at least one connecting surface area. The two connecting surface areas lie opposite each other, and the two bodies are wrung together along at least one connecting surface area. At least one of the connecting surface areas has recesses for an adhesive bond or for an adhesive bonding gap.

A composite body is described in DE 197 55 483 A1 which is joined together of at least two bodies, wherein the first body consists of a first material and the second body consists of a second material. Each of the two bodies has at least one connecting surface area; the two connecting surface areas lie opposite each other. The two bodies are connected to each other by at least one adhesive connection. At least one of the connecting surface areas has at least one recess for a compensating body of a third material. The compensating body is connected to the two bodies through at least one adhesive bond or an adhesive bonding gap, wherein an adhesive agent provides an adhesive connection between the compensating body and the two bodies at the adhesive bond.

Methods that have been used heretofore for the connection of glass parts are wringing, adhesive bonding, and clamping. With these methods, the entire surface areas that are available for the attachment are used in most cases. In all of the methods, stresses of a considerable magnitude are generated, so that the optical surfaces of the components are deformed. Even if the deformations are removed by polishing after the joining of the individual parts, due to a relaxation process extending over the lifetime of the components, the deformations will reappear at least in part either as negatives of their original shape or at different locations. For example if the surfaces are joined by wringing, both contact surfaces are deformed. When surfaces are adhesively bonded, problems are encountered with the stability over time and with deformation due to shrinking and relaxation processes.

### OBJECT AND SUMMARY OF THE INVENTION

It is an object of the present invention, to lessen the deformations of one or both of the bodies at their sensitive surfaces because of the connection between them and to ensure a connection that is stable over time.

According to the invention, this objective is achieved in a composite body of the type that was referred to hereinabove through the concept that within or close to the at least one connecting surface area of one of the two bodies at least one constructive means is arranged for isolating the first and/or the second body from deformation.

As a result of the invention, a connection is created between two different components which represents a geometric solution of the task of containing or isolating a mechanical stress caused by the internal forces in the connection between the two components, wherein the stress is of the kind that occurs for example when an optical sensor grid, a graduated platelet for a position measurement or the like is attached to an optical component, which will cause a deformation or other effect in optically sensitive surfaces of the optical component. A very large part of stresses of this kind can be intercepted or isolated far from the optical surfaces. Thus, there can no longer be an influence on the optical surface even from relaxations of connections between the two bodies which may consist, e.g., of glass or a glass ceramic. The invention is particularly well suited for isolating the stresses of optical surfaces; but it is also suitable for isolating other sensitive surfaces from stresses, for example surfaces that serve for the measurement of a position.

In accordance with the invention, individual point-shaped contact areas are used for making a connection. These contact points are provided with a stress isolation. Under this concept, only localized connecting forces occur. The contact areas are configured so that no stresses propagate from the connecting forces through the components, but that the stresses remain locally contained. The stress isolation is carried out all the way around a point of tensile stress. However, the stress isolation can also be limited to certain critical directions on the first body, which includes the optical component.

Advantageous further developed embodiments of the invention are presented in the dependent claims, in the description and in the drawings.

In an advantageous further developed embodiment, the second body includes parts of an arrangement for measuring a position, or it includes surfaces performing an optical function.

Likewise advantageous is an embodiment of the invention where the constructive means is constituted by a hollow space or a slot between the two bodies. In addition or as an alternative to this measure, the hollow space, the slot, or the groove is arranged inside one of the two bodies in the proximity of the other body. In this case, the hollow space or the slot or the groove is always arranged in the direction—seen from the connecting area between the two bodies—where the sensitive surface area is located that is to be protected from the effects of deformations.

In a further developed embodiment of the invention, it is envisaged that the constructive means is constituted by a hollow space between the two bodies and that the connecting surface areas are formed by at least three approximately point-shaped areas located on ridges that project out of the second body in the direction towards the first body. By using three connecting areas, a connection that is close to statically determinate is created between the components. Consequently, uneven areas in the surfaces cause no deformation. In principle, this goal can be achieved only approximately. The connecting areas are made so soft that they will absorb the main share of the adaptation between the surfaces, so that the components themselves are hardly deformed at all.

As an advantageous feature, a composite body is characterized in that each of the connecting surface areas or adjacent connecting surface areas is configured partially as a compressively stressed surface and partially as a tensile-stressed surface.

Under the latter concept, the composite body is advantageously configured in such a manner that the tensile stress can be generated by a connecting means for connecting the two bodies, in particular by screws, tension anchors, springs and the like, or by the contraction, that takes place during the hardening of an adhesive agent.

The tensile force in the tensile area is matched by a compressive force of the same magnitude in the compression area. The friction force generated by the compressive force in the contact plane ensures that the two parts are not slipping relative to each other.

In a further advantageous embodiment of the invention, at least one groove or at least one recess other than a groove is provided which at least partially surrounds the at least one connecting area. Through this measure, the points of contact at the connecting surface areas between the two bodies can be isolated against stresses, so that localized stresses generated by the contacts have no influence on the other areas of the components.

The stress isolation is carried out preferably all the way around the centers of tension of the individual connecting surface areas. As an example, the composite body is characterized in that the at least one groove runs concentric to the center of the at least one connecting surface area or to a center of tension of a tensile force that has been caused in each connecting area between the two bodies as a consequence of joining them together, or in that recesses are arranged symmetrically in relation to the center of the at least one connecting surface area or in relation to the center of tension. However, it may also be sufficient if only the stress in the direction of the critical surface is isolated.

The invention also relates in particular to an embodiment in which the at least two grooves are symmetric to the center of the at least connecting area or to a center of tension of a tensile force that has been caused in each connecting area between the two bodies as a consequence of joining them together, or in that recesses are arranged symmetrically in relation to the center of the at least one connecting surface area or in relation to the center of tension. If there is more than one connecting surface area, the grooves can be symmetric, in particular concentric, in relation to the common center of symmetry of the connecting surface areas.

The grooves and the recesses can have different shapes. A configuration is suitable in which the recesses are of a conical, cylindrical or hemispherical shape, or where the grooves have a semicircular, triangular or rectangular cross-section. The compressive area can be configured as one contiguous area or it can be designed with interruptions. Preferably, the compressive area is of a symmetric shape, but it can also be shaped asymmetrically.

According to another advantageous embodiment, a groove is configured as a round groove, and the ratio of the internal diameter to the depth of the groove is between 1.5:1 and 5:1.

According to a further advantageous embodiment, if there are two grooves that are arranged parallel to each other, the ratio of the distance between the grooves to the depth of the grooves is between 1.5:1 and 5:1.

According to an advantageous embodiment, the constructive means is formed by ridges or legs, which project next to the at least one connecting, surface area of the second body and reach to the first body.

An embodiment is advantageous where the at least one connecting surface area of the second body has a triangular, quadrilateral, circular or other geometric shape and/or has an interrupted compressive area.

The composite body is advantageously put together in such a way that the friction coefficients of the connecting surface areas are altered by a surface treatment, in particular by coating, cleaning or polishing.

The two bodies are connected to each other by at least one projection or at least one pin or at least one ridge. As an example, the tow bodies can be connected to each other through two ridges. A ring shaped connecting element in particular is likewise a suitable means for connecting the two bodies. The connection between the two bodies is established either through elements that belong to the two bodies or through at least one separate connecting element.

In accordance with the invention, the decoupling of the deformation can be split up between the two components that are to be connected, but as an alternative, the decoupling can also be implemented in only one of the two components. In any case, the stresses are isolated against propagating towards the sensitive surfaces. The points of contact are preferably designed in such a way that no external force is required in order to establish a secure contact.

The points of contact are designed in such a way that no external force is required in order to establish a secure contact. To accomplish this, each individual contact is composed of a tensile area and a compressive area, with the compressive area also taking up the surface shear forces which are caused for example by friction.

The tension can be generated by any desired machine element, for example by screws, springs or tension anchors, preferably however by means of an adhesive bonding agent.

It needs to be assured that the tensile connection that is being used will always generate the necessary amount of tension so that a sufficiently large surface shear force, for example as a result of friction, is available in order to generate a secure attachment. Furthermore, when the tensile connection is closed, no additional stresses other than the absolutely necessary tensile and compressive stresses should be locked in. The compressive area can be designed as a friction surface or a joining surface for a wrung connection.

The overall advantages of the invention in relation to the state of the art are based on the concept that a stress can be isolated for example by a groove and will thus not propagate over wide areas of the components; consequently, the components are deformed only locally in areas that are not relevant for the radiation that is transmitted or reflected by the optical component.

While the joining technique of wringing according to the state of the art is always implemented over a full surface or the wringing surface is at best evenly reduced by etching over the entire possible contact surface, with the reduction of the joining surface to localized areas according to the invention the surfaces need no longer be in full contact with each other and therefore no longer have to be deformed so strongly. This is conducive to lower stresses.

Adhesive bonding agents are normally subject to creep over a longer time span. However, in the present invention the adhesive bonding agent is used in such a way that the creeping of the adhesive causes no relative movement between the components. The deformations are caused by the connection forces, which in this case originate from the adhesive. If this influence is isolated, neither the influence itself nor its change will lead to a deformation of the optical surface. In order to ensure that the connection remains functional, one merely needs to ensure that the adhesive relaxes only so far that the compressive contact force cannot fall below the required level.

By using for example three contacts, one can achieve that the two components are tied together in almost a statically determinate way. The body that is to be joined to the first body containing the optical component has for example the elastic or soft legs by which it is brought into contact with the first body. The desired elasticity is a result of the feature that the raised elements or legs on the body to be joined have a very small cross-section or are additionally or alternatively equipped with recesses or grooves in order to generate an elasticity that is channeled in certain directions. The soft legs allow surface deviations of the two bodies to be compensated against each other. Instead of using soft legs, one can also use components with highly planar surfaces.

Depending on the stiffness of the connection and the surface specification of the optical components to be joined together, the number of contact areas can be increased. The surface condition, i.e., the roughness, the degree of purity or the coating can be varied in the area of the contacts in order to influence the coefficient of friction.

The invention further relates to an arrangement comprised of an optical precision element and a body which together form a connecting region between a surface of the optical precision element and the body that is fastened to that surface, with a first surface area on the precision element taking up tensile or compressive forces, with a third surface area on the body located approximately opposite the first surface area and taking up tensile or compressive forces, a second surface area on the precision element, and a fourth surface area on the body, wherein the second and fourth surface areas are in direct or indirect contact to each other and thereby determine the arrangement of the precision element and the body in the direction of the tensile or compressive forces, and wherein at least the first and/or third surface area is at least partially surrounded by grooves or recesses in the surface of the optical precision element and/or the surface of the body.

### BRIEF DESCRIPTION OF THE DRAWINGS

The invention will hereinafter be explained in more detail through examples of embodiments with references to the drawings, wherein:

FIG. 1 represents a plan view of a first body comprising an optical component, with several second bodies laterally attached,

FIGS. 2a, b represent, respectively, a sectional- or side view and a schematic plan view of a detail portion of the first body, with a second body attached to it through an ideal three-point contact,

FIGS. 3, 4 represent sectional views across a section of a first body on which a second body is attached, focusing on the area of the connection,

FIGS. 3a-c represent plan views of grooves arranged in the first body,

FIGS. 4a-d represent sectional views of the first body with grooves or a slot arranged in it,

FIGS. 5a, b represent sectional views of a section of the first body with two grooves arranges side by side or with a circular groove,

FIG. 6 represents a first body which includes an optical component, with several second bodies attached to the first body, wherein the first body has hollow spaces or grooves arranged near each of the second bodies,

FIG. 7 represents a further body with an optical component on whose side a further body is arranged, and

FIG. 8 represents a further view of a section of a first body with a second body fastened to it, wherein separate spacer elements are placed between the two bodies.

### DETAILED DESCRIPTION OF PREFERRED EMBODIMENTS

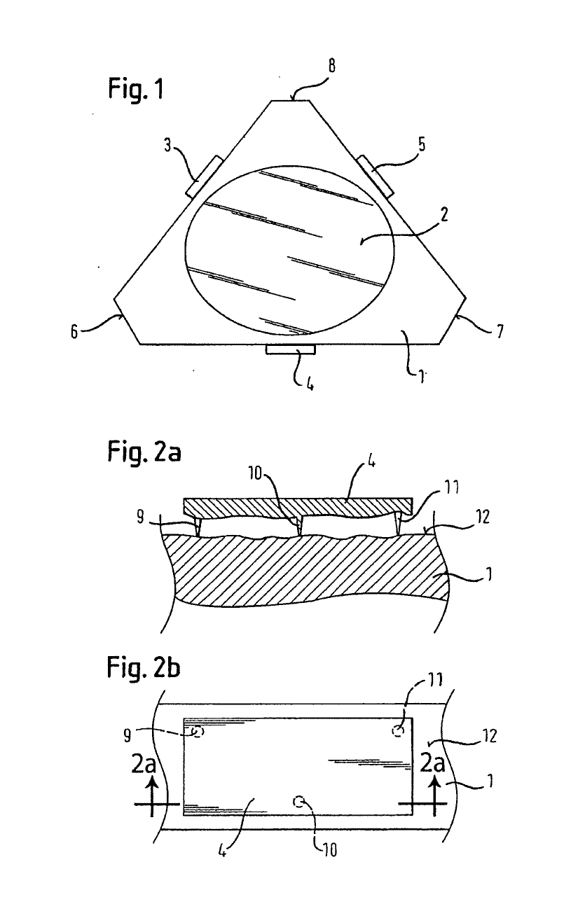

A first body 1 (FIG. 1) monolithically includes an optical component with an optical surface 2 serving for example as a mirror. Attached to the lateral surfaces of the body 1 are platelets 3, 4, 5 which can be equipped, e.g., with a graduated scale.

Consistent with the bonding technique of the present invention, the platelet 4 (and analogously also the platelets 3, 5) have three legs 9, 10, 11 (FIGS. 2a, b) with a narrowing taper in the direction of the body 1 in order to form contact areas with the surface 12 of the body 1 that are as small as possible and nearly point-shaped, so that the platelet 4 is kinematically constrained on the body 1 (in an ideal execution of the concept, the legs 9, 10, 11 form point-shaped contacts with the surface 12).

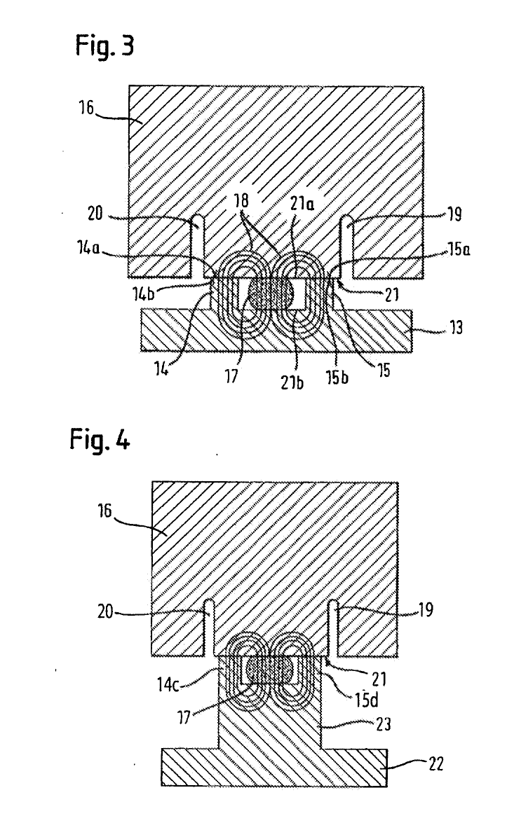

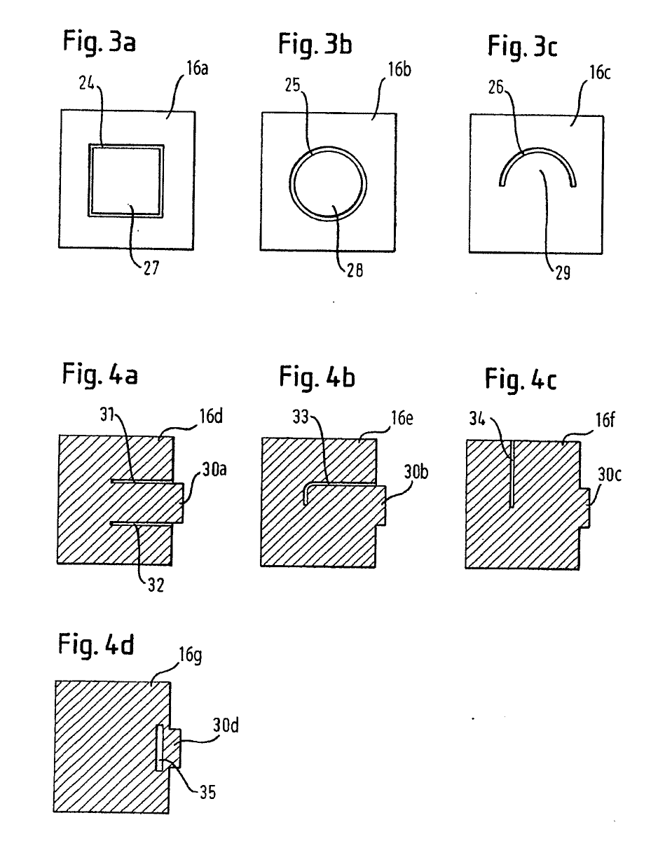

In another embodiment (FIG. 3) a platelet 13 which carries a graduated scale (not shown here) is fastened on a first body 16 by means of legs 14, 15 or by means of a narrow fastening ring. An adhesive bonding agent in the form of a globule 17 is placed in the area between the legs 14, 15 or inside the ring between the platelet 13 and the body 16, and as the adhesive contracts while it hardens, it exerts a contractive force between the platelet 13 and the body 16. This creates stresses 18 through the legs 14, 15 or through the fastening ring. In order to prevent the stresses from influencing the shape of the optical component that is integrated in the body 16, there are grooves 19, 20 recessed into the body 16 in the vicinity of the legs 14, 15. With preference, a single ring-shaped groove is used. The platelet 13 is joined at its legs 14, 15 to the surface 21 of the body 16, preferably by wringing.

It is understood that between the body 16 and the platelet 13 there can be a multitude of attachment- or connecting areas, each of which is configured in the manner illustrated in FIG. 3 or similar to it.

In another embodiment, a platelet 22 arranged on the body 16 (FIG. 4) has a projection 23 extending towards the body 16, configured as a single long leg which receives the small legs 14, 15 or a ring-shaped projection to form the connection to the body 16. Otherwise, the arrangement of FIG. 4 is analogous to that of FIG. 3. The projection 23, likewise, serves to isolate and contain the stresses within a narrow spatial domain inside the platelet 22. Thus an isolation of the deformation is realized on both sides, i.e., in the body 16 as well as in the platelet 22. Grooves and raised legs can be arbitrarily combined and are equivalent as a means for stress isolation. Whichever geometric element is used, it isolates the stress on the side on which it is located in relation to the adhesive bond. As in the preceding case of the body 16 and the platelet 13, there can likewise be a multitude of connections between the body 16 and the platelet 22, which are configured as is illustrated in FIG. 4 or in a similar way. The connections shown in FIGS. 3 and 4 between the body 16 and, respectively, the platelets 13 or 22 can also be combined with each other.

The two embodiments of the present invention which have been described above in the context of FIGS. 3 and 4 can also be generalized in such a way that the present invention includes the case of a connecting region between a surface 21 of a body 16 configured as an optical precision element 16 and a body 13, 22 that is fastened to the surface 21, wherein the connecting region includes a first connecting surface area 21a on the precision element 16 taking up tensile and/or compressive forces, as well as a third connecting surface area 21b which is located approximately opposite the first connecting surface area 21a, takes up tensile and/or compressive forces, and is arranged on the body 13 or 22. The connecting region also includes a second connecting surface area 14a, 15a on the precision element 16 and a fourth connecting surface area 14b, 15b on the body 13 or 22, wherein the second connecting surface area 14a, 15a and the fourth connecting surface area 14b, 15b through direct contact of said connecting surface areas 14a, 15a, 14b, 15b with each other determine the arrangement of the precision element 16 and the body 13, 22 in the direction of the tensile and/or compressive forces. The connecting region according to the invention further includes the grooves 19, 20 or recesses which at least partially surround at least the first connecting surface area 21a and/or the third connecting surface area 21b. Not shown in FIGS. 3 and 4 are grooves that may be arranged around the third connecting surface area 21b. Grooves or recesses of this kind in the vicinity of the third connecting surface area 21b are advantageous, e.g., to minimize the deformation of the body caused by tensile or compressive forces which are necessary for the connection of the body 13, 22 with the optical precision element 16 and which are acting on the first and third connecting surface areas.

In the embodiments of FIGS. 3 and 4, the tensile or compressive forces acting on the first surface area 21a and the third surface area 21b are generated by means of the adhesive bonding agent 17. Other means for generating tensile or compressive forces are likewise possible.

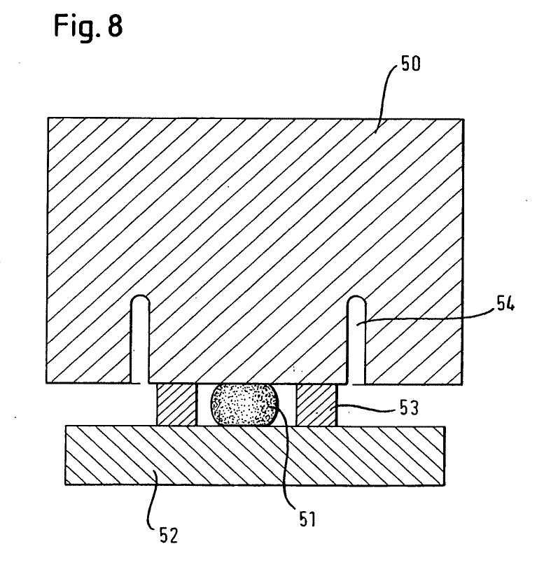

The tensile or compressive forces that are taken up by the first surface area 21a and the third surface area 21b serve the purpose of holding the body 13, 22 on the precision element 16. The second surface areas 14a, 15a and the fourth surface areas 14b, 15b are abutting surfaces or contact surfaces which, when tensile or compressive forces are acting between them, serve to keep the body 13, 22 and the precision element 16 in a defined position relative to each other, preferably in the direction of the tensile or compressive forces. Preferably, but not necessarily, the aforementioned surface areas are in direct contact with each other, i.e., they abut each other. An indirect contact is likewise possible, for example if an intermediate element is arranged between the second surface 14a, 15a and the fourth surface 14b, 15b. The intermediate element can be, for example, a defined spacer- or connector element 53 (for example as in the embodiment that is described in the context of FIG. 8), in order to achieve a dimensionally accurate positioning of the body 13, 22 in relation to the precision element 16.

Accordingly, under this generalized embodiment there is a connecting region between a surface of an optical precision element and a body that is fastened to said surface, with a first surface area on the precision element taking up tensile or compressive forces, with a third surface area on the body located approximately opposite the first surface area and taking up tensile or compressive forces, a second surface area on the precision element, and a fourth surface area on the body, wherein the second and fourth surface areas are in direct or indirect contact to each other and thereby determine the arrangement of the precision element and the body in the direction of the tensile or compressive forces, and wherein at least the first and/or third surface area is at least partially surrounded by grooves or recesses in the surface of the optical precision element and/or the surface of the body.

In a further preferred embodiment of the connecting region according to the invention, the second surface areas 14a, 15a and/or the fourth surface areas 14b, 15b are likewise surrounded at least partially by grooves or recesses 19, 20 in the surface of the optical precision element and/or the surface of the body. This concept is realized, e.g. in FIGS. 3 and 4, with the grooves 19 and 20 which likewise surround the second surface areas 14a, 15a.

Accordingly, the present invention, encompasses an optical precision element 16 with a surface 21, a connecting region that is formed on the surface 21 and serves to fasten a body 13, 22, wherein the connecting region is comprised of at least two partial regions with a first surface area 21a and a second surface area 14a, 15a, wherein the first surface area 21a, when it is connected to the body 13, 22, takes up tensile and/or compressive forces, wherein the second surface area 14a, 15a determines the position of the body 13, 22 in at least one direction relative to the precision element 16, and wherein the first surface area 21a and/or the second surface area 14a, 15a is surrounded at least in part by grooves 19, 20 or recesses 19, 20 in the surface 21. Preferred embodiments are presented in FIGS. 3 and 4.

The second surface area 14a, 15a in these embodiments preferably determines the relative position of the body 13, 22 in the direction of the tensile or compressive forces acting on the precision element.

The body 1 or the body 16 can be provided with grooves 24, 25 running in a closed loop (FIGS. 3a, b) or semicircular grooves 26 below each of the platelets 4, 5, 6 or below the platelet 13 or the platelet 22, wherein each of the grooves forms a border around a contact area 27, 28 or a lateral border of a contact area 29.

In a further embodiment, the body 1 or the body 16 or another body is equipped with a projection 30 (FIGS. 4a-d) which forms or delimits the contact area to a platelet 4, 5, 6 or 13 or 22. In each case, there are grooves 31, 32 or 33 arranged laterally of the projection 30. The groove 33 has an L-shaped cross-section. Other shapes of cross-sections, for example T-shaped, can likewise be realized.

In the case of the embodiment according to FIG. 4c, a groove 34 extends parallel to the contact surface formed by the projection 30. Instead of a groove, there can also be a slot 35 within the body 1 running parallel to the contact surface of the projection 30. Even if there is no projection 30, there can be a slot 35 below the area of contact with the platelet 4, 5, 6, 13 or 22. The slot 35 can also be used in combination with the grooves 19, 20 or 31 to 34 as a further means for the isolation of stresses.

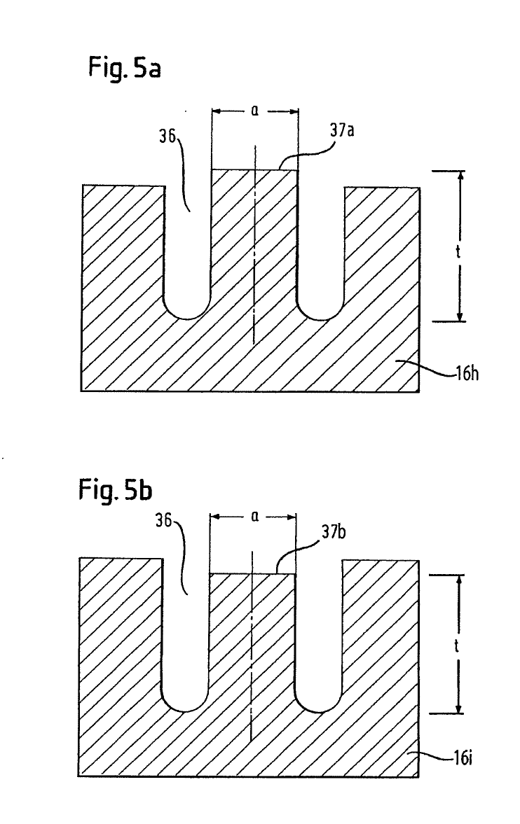

Instead of a single groove 24, 25 surrounding a rectangular or circular area, one can also use a circular groove 36 (FIGS. 5a, b) within the body 1 or 16 as a stress relief groove which delimits an area 37 that is raised above the surface of the body 1, 16 and serves to establish a connection with the second body. The depth t of the groove 36 and its radial distance from the center of the area 37 are in this case preferably in a proportion between 1.5:1 and 5:1. The area 37 either is raised above (FIG. 5a) or recessed below (FIG. 5b) the zone that lies outside of the connecting area with the second body.

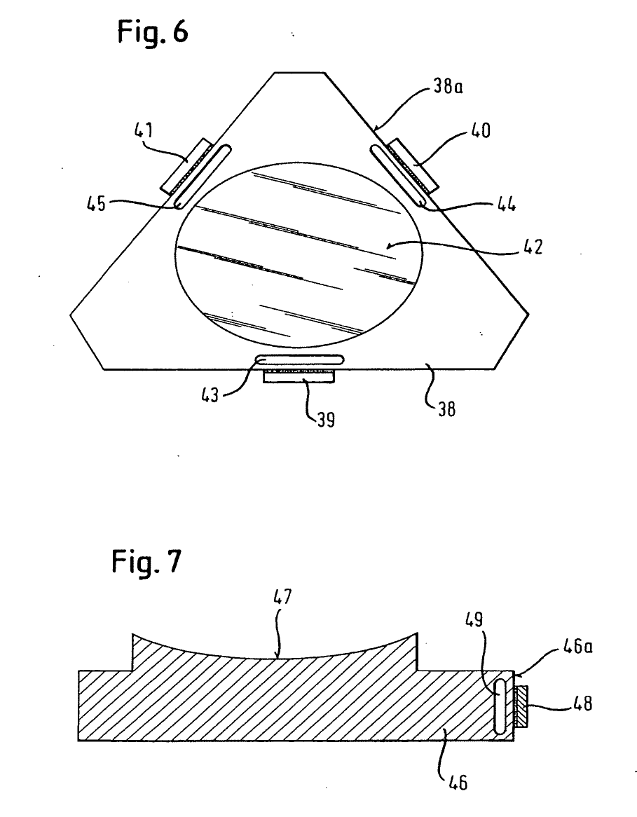

Similar to the body 1 shown in FIG. 1, a body 38 as illustrated in FIG. 6 has a plurality of second bodies 39, 40, 41 fastened to it through adhesive connections. As a means to keep an optical surface 42 in the center of the body 38 isolated from the stresses that are generated by this connection, the body 38 is provided with grooves or hollow spaces 43, 44, 45 traversing the body 38 in immediate proximity to the second bodies 39, 40, 41.

In a body 46 (FIG. 7) which includes an optical surface 47 the stress isolation at a connection with a body 48 is realized by means of a groove or a hollow space 49 located near the body 48.

Generally, an embodiment of the present invention in accordance with FIGS. 6 and 7 can include an optical precision element 38, 46 with a surface 38a, 46a located at a distance from an optical surface 42, 47, a connecting region formed on the surface 38a 46a for fastening a body 40, 48, wherein the connecting region has at least two partial regions with a first and a second surface area, wherein the first surface area—when it is connected to the body—takes up tensile or compressive forces, the second surface area determines the relative position of the body in at least one direction relative to the precision element, and wherein the first and second surface areas are at least partially separated by a recess 44, 49 between the optical surface 42, 47 and the surface area 38a, 46a. In the examples of FIGS. 6 and 7, the first and second surface areas coincide and are constituted by the surface area of the precision element that is in contact with the body 40, 48. This is the case, e.g., if the body 40, 48 that is to be connected is joined by wringing to a surface 38a, 46a of the precision element 38, 46. As an alternative, the first and second surface areas can be realized in accordance with the embodiments described above, in particular if the tensile or compressive forces for holding the body on an optical precision element are transmitted by means of an adhesive bonding agent.

The scope of the present invention also includes a body with a body surface designed for attachment to a surface of an optical precision element in accordance with one of the aforementioned embodiments. The body in this case has a connecting region formed on the body surface for the attachment to the surface of the precision elements, wherein the connecting region, like the connecting regions described above, is comprised of at least two partial regions with a third and a fourth surface area, wherein the third surface area—when it is connected to the precision element—takes up tensile and compressive forces corresponding to the first surface area of the precision element, the fourth surface area in correspondence with the second surface area of the precision element determines the relative position of the body in at least one direction relative to the precision element, and wherein the third and/or fourth surface area is surrounded at least in part by grooves or recesses in the body surface. The third and fourth surface areas can coincide here in a case where the body and the precision element are joined together by wringing. As an alternative, the third and fourth surface areas can be of an analogous configuration as the above-described embodiments for the first and second surface areas of the precision element, particularly in cases where the tensile and compressive forces for holding the body connected to an optical precision element are imparted through an adhesive bonding agent.

In a further embodiment (FIG. 8), a body 50 is connected to a body 52 by way of a region 51 formed by an adhesive. The adhesive generates a contractive force which gives rise to a compressive force acting on a spacer- or connector element 53 which extends like a ring around the region 51. In order to isolate the optical surfaces of the body 50 from deformations which as a result of the contractive and compressive forces occur in the body 50 near the connection between the bodies 50 and 52, the body 50 is provided with a ring-shaped groove 54 that functions as an isolating groove. Instead of the one groove 54, there can also be a plurality of grooves, each of which is arranged laterally outside of the connecting area where the spacer element 53 meets the body 50. This means that in the interior space, too, which is surrounded by the spacer element 53, there can be a ring-shaped groove or other kinds of recesses arranged in the body 50 either in addition or as an alternative to the grove 54. The spacer element 53 is held in place exclusively by the friction force or by a wringing connection between the bodies 50 and 52.

The spacer element 53 is either formed as an additional component as shown in FIG. 8, or it consists of a circular projection of the body 50 or the body 52. It is considered self-evident that between the bodies 50, 52 there can be a multitude of spacer elements which are configured like the spacer element 53. Likewise, there can also be another element or a plurality of other elements between the bodies 50, 52 to maintain a required distance, for example shaped like the small legs 14, 15 shown in FIGS. 3 and 4.

The present invention is not limited to the embodiments described hereinabove. It also includes such configurations as may be obtained by combining and/or interchanging features of individual embodiments.

1.-26. (canceled)

27. An optical precision element with a surface, a connecting region formed on the surface for fastening a body, wherein the connecting region comprises at least two parts with a first and a second surface area, wherein the first surface area, when it is connected to the body, takes up forces acting in one of a compressive and a tensile direction, the second surface area determines the relative position of the body in at least one direction relative to the precision element, and wherein at least one of the first and second surface areas is surrounded at least in part by one of grooves and recesses in said surface.

28. An optical precision element with a surface located at a distance from an optical surface, a connecting region formed on the surface for fastening a body, wherein the connecting region comprises at least two parts with a first and a second surface area, wherein the first surface area, when it is connected to the body, takes up forces acting in one of a compressive and a tensile direction, the second surface area determines the relative position of the body in at least one direction relative to the precision element, and wherein the first and second surface areas are at least partially separated by a recess between the optical surface and the surface.

29. (canceled)

30. An arrangement comprising an optical precision element and a body forming together a connecting region between a surface of the optical precision element and the body which is connected to said surface of the optical precision element, said connecting region comprising a first surface area on the precision element taking up forces in one of a tensile and a compressive direction, further comprising a third surface area on the body lying substantially opposite the first surface area and taking up forces in one of a tensile and a compressive direction, further comprising a second surface area on the precision element and a fourth surface area on the body, wherein the second and fourth surface areas by a direct contact with each other determine the arrangement of the precision element and the body in the direction of said forces, and wherein at least one of the first and third surface areas is at least in part surrounded by one of grooves and recesses in one of the surface of the optical precision element and the surface of the body.

31. The optical precision element according to claim 27 wherein the grooves or recesses are designed as a slot.

32. The optical precision element according to claim 27 wherein the grooves have a circular form and delimit a circular area.

33. The optical precision element according to claim 32 wherein the depth of each of the grooves and their radial distance to the circular area or the internal diameter of the circular area is in a proportion between 1.5:1 and 5:1.

34. The optical precision element according to claim 27 wherein the grooves delimit an area that is raised above or recessed below the surface of the precision element.

35. The optical precision element according to claim 34 wherein at least two grooves are arranged symmetrically relative to the center of the at least one of the first and the second surfaces are arranged parallel to each other and the distance between grooves and the depth of the grooves are in a proportion of 1.5:1 and 5:1.

36. The optical precision element according to claim 27 wherein ridges or legs or a projection or a pin project next to the connecting region of the body reach towards the optical precision element.

37. The optical precision element according to claim 27 wherein the connection region has one of a triangular, quadrilateral, or circular form.

38. The optical precision element according to claim 27 wherein the first surface area comprises an interrupted compressive area.

39. The optical precision element according to claim 27 wherein the first surface area has a friction coefficient that has been altered by a surface treatment, selected among treatments of coating, cleaning and polishing.

40. The optical precision element according to claim 27 wherein the body comprises a ring-shaped connector element or a separate connector element.

41. The optical precision element according to claim 27 wherein the body has a body surface for attachment to the surface of the optical precision element, a connecting region formed on the body surface for attachment to the surface of the precision element, wherein the connecting region of the body comprises at least two parts with a third and a fourth surface area, wherein the third surface area, when it is connected to the precision element, takes up forces acting in one of a compressive and a tensile direction, the fourth surface area determines the relative position of the body in at least one direction relative to the precision element, and wherein the third and fourth surface areas are at least partially separated by one of grooves and recess in the body surface.

42. The optical precision element according to claim 27 wherein a spacer or connector element extends like a ring in the connecting between the optical precision element and the body.

43. The optical precision element according to claim 28 wherein the grooves or recesses are designed as a slot.

44. The optical precision element according to claim 28 wherein the grooves have a circular form and delimit a circular area.

45. The optical precision element according to claim 44 wherein the depth of each of the grooves and their radial distance to the circular area or the internal diameter of the circular area is in a proportion between 1.5:1 and 5:1.

46. The optical precision element according to claim 28 wherein a spacer or connector element extends like a ring in the connecting between the optical precision element and the body.

47. The optical precision element according to claim 28 wherein the body has a body surface for attachment to the surface of the optical precision element, a connecting region formed on the body surface for attachment to the surface of the precision element, wherein the connecting region of the body comprises at least two parts with a third and a fourth surface area, wherein the third surface area, when it is connected to the precision element, takes up forces acting in one of a compressive and a tensile direction, the fourth surface area determines the relative position of the body in at least one direction relative to the precision element, and wherein the third and fourth surface areas are at least partially separated by one of grooves and recess in the body surface.
